(19) United States
(12) Patent Application Publication
(10) Pub. No.: US 2005/0228872 A1
(43) Pub. Date: Oct. 13, 2005

(54) Web server with integrated automatic functionality and direct access to a transport layer

(76) Inventors: Rolf-Dieter Pavlik, Erlangen (DE); Gernot Rossi, Simmelsdorf (DE); Frank Volkmann, Nurnberg (DE)

Correspondence Address: Siemens Corporation;Intellectual Property Department, 170 Wood Avenue South, Iselin, NJ, 08830, US

(21) Appl. No.: 10/510,221

(22) PCT Filed: Mar. 24, 2003
(86) PCT No.: PCT/DE03/00965

§ 371 Date: Oct. 1, 2004

(30) Foreign Application Priority Data
Apr. 2, 2002 (DE) 102 14 538.5

(51) Int. Cl. G06F 15/16

(52) U.S. Cl. 709/219; 709/220

(57) ABSTRACT

The invention relates to a web server having software modules integrated into the web server, supporting different communication means. At least one first software module comprises a first means for producing an automatic functionality and a second means for the direct access to a transport layer.

The invention relates to a web server having software modules integrated into the web server and an automation system or a computer program product with such a web server.

Servers, which are connected via the internet to clients and supply these with information, generally internet pages, are known as web servers. Such a web server is an application, which runs in a distributed manner on one or a plurality of computers. Data is stored centrally on the web server and can be used by a plurality of different clients, regardless of the respective location of a client. Web server refers to both the software application operating on a computer and the computer itself. Web servers are currently used as the universal information supplier on the internet as well as on local networks based on internet technologies. The option of expansion modules for web servers is frequently utilized, e.g. to allow access to databases, forms, etc. Communication between client and web server generally operates according to the HTTP protocol (HTTP=Hyper Text Transfer Protocol).

U.S. Pat. No. 6,061,603 A describes a control system, which allows a user to access a stored-program control via a communication network, e.g. the internet, using a web browser. The system comprises an interface between the network and the stored-program control. This so-called web interface supplies internet pages from an Ethernet interface of the stored-program control and contains an HTTP protocol interpreter and a TCP/IP stack (TCP/IP=Transmission Control Protocol/Internet Protocol). The web interface therefore offers a remote user access to the stored-program control via the internet.

The object of the invention is to highlight a possible solution for providing an automation functionality, which supports different types of communication.

This object is achieved with a web server with software modules, with which at least a first software module comprises a first means for providing an automation functionality and a second means for direct access to a transport layer.

The invention is based on the knowledge that the conventional world of automation currently has few areas of contact with the internet, as proprietary protocols are primarily used in automation technology. Developments in web technology are however moving forward without taking into account questions raised by automation technology. Previous approaches, involving integrating specific web server functionalities into the automation components, are in turn based on proprietary solutions for the individual components. Also the potential of such solutions proved very limited. The inventive web server combines web technology with automation technology in a surprising manner, in that an expansion module, generally a software module, integrated directly into the web server provides the required automation functionality. A web server with such functionality expansion can process both complex tasks of conventional automation technology and more minor tasks, e.g. in the consumer field. Direct integration of the automation functionality into the web server means that existing web implementations can also be used when processing automation tasks. The second means of the first software module for direct access to a transport layer also opens up a communication route that is independent of web technologies.

Connecting the inventive web server to a communication network, particularly the internet, on the one hand makes internet technologies available to automation technology and on the other hand provides a continuous interface between the automation components and the communication network.

The use of internet protocols for communication between the software modules themselves and for communication between the software modules and components outside the web server allows standardization of the web server components with regard to their communication interfaces. Expansion of the web server with further modules is facilitated, as these can be used without expensive adaptation to proprietary protocols. Examples of standard internet protocols are HTTP and FTP (File Transfer Protocol).

In one advantageous embodiment of the invention the web server is provided to configure and administer the software modules.

The inventive web server is easily scalable and therefore can be used according to a further advantageous embodiment to control components in an industrial automation system, if the first software module has a connection to the industrial automation system.

In order to use available internet security mechanisms, it is proposed that the web server should have a connection to the internet via a firewall. The security mechanisms required in the internet cannot generally be provided in the current standard web server expansions integrated into an automation component due to the restricted amount of free space.

The connection between the web server and a communication network, in particular the internet, can advantageously be used to support the automation functionality, if the web server is connected via a communication network to a web browser as the control and monitoring system for the automation system controlled by the first software module. This control and monitoring system can also be used for project planning, programming, the implementation of software updates, i.e. generally for data communication and data representation.

To allow the use of web technologies for real-time applications as well, it is proposed that the web server should have a real-time operating system. During use in process automation in particular the automation components used must be real-time-compatible. This requirement can be met by coupling the first software module to the real-time operating system. The real-time operating system can be used in addition to a non-real-time-compatible operating system (component) or as a standalone operating system.

The invention is described and explained in more detail below with reference to the exemplary embodiments shown in the Figures, in which:

FIG. 1 shows a system with web servers connected via the internet, which carry out different tasks,

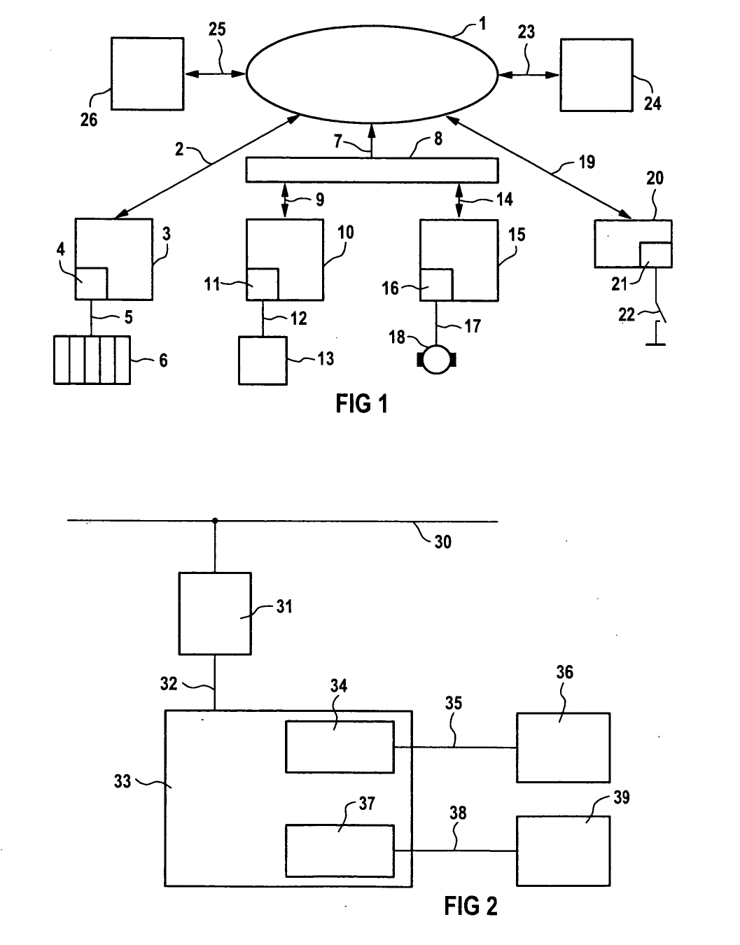

FIG. 2 shows a web server with automation functionality,

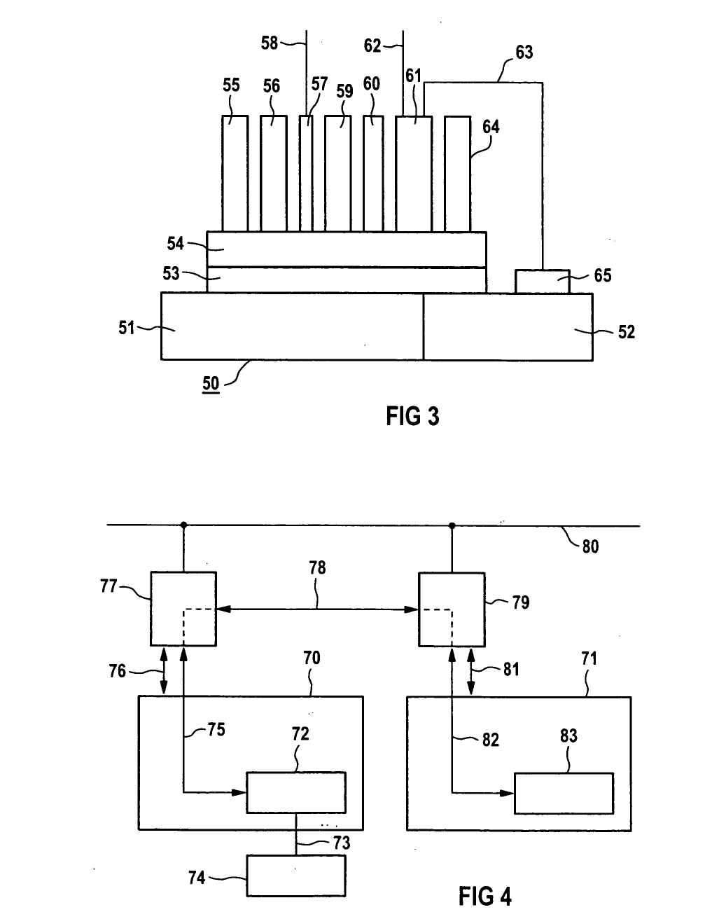

FIG. 3 shows a schematic view of the structure of a web server with automation functionality,

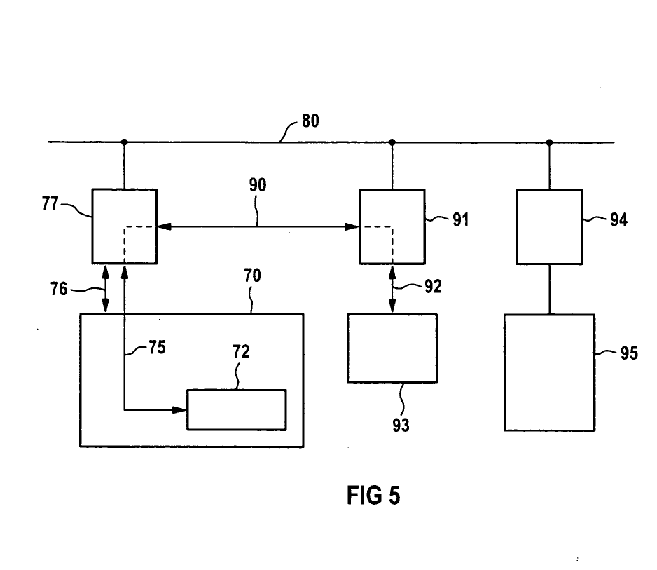

FIG. 4 shows a system with web server connected via the internet and a proprietary connection and

FIG. 5 shows a system with combined use of a web server with automation functionality, an automation device and a conventional web server without automation functionality.

FIG. 1 shows different web servers 3, 10, 15, 20, 24, which are connected together directly or indirectly via the internet 1. A first web server 3 communicates directly via a connection 2 with the internet 1. The first web server 3 contains an expansion module 4, which is connected via a connection 5 to an input/output module 6 of an automation system. A second and third web server 10, 15 are connected via connections 9, 14, a firewall 8 and a connection 7 to the internet 1. The second web server 10 has an expansion module 11, which has a connection 12 to a converter 13. The third web server 15 contains an expansion module 16, which controls a drive 18 via a connection 17. A fourth web server, a so-called embedded web server, identified with the reference character 20, is connected directly via a connection 19 to the internet 1 and has an expansion module 21, which controls a valve 22. The fifth web server 24 shown in FIG. 1 has no automation functionality and communicates with the internet via a connection 23. A web browser 26 is linked via a connection 25 to the internet 1.

The idea behind the invention will be explained below with reference to FIG. 1. A web server is a process on a computer—or even distributed across a plurality of computers—and generally supplies a large number of clients (web browsers on different devices) with information. This information can either exist statically on the web server or can be generated dynamically from other service programs. Standard communication partners connected via the internet 1 are therefore web servers in the configuration of the fifth web server 24 and web browser 26. The fifth web server 24 provides information, generally internet pages, at the request of a web browser 26 via the internet 1.

The idea behind the invention involves configuring such a standard web server by expansion by means of software modules, such that it can also carry out automation tasks. The first web server 3 contains an expansion module 4, which takes over the tasks of a stored-program control (SPC). The expansion module 4, as part of the web server 3, is connected for this purpose by means of a connection 5 to an input/output module of an automation system. The first web server 3 therefore serves not only to supply information via the connection 2 to the internet 1 but the integration of the expansion module 4 means that it can also execute complex control tasks, which in the prior art to date could only be executed by standalone stored-program controls. FIG. 1 shows a further exemplary embodiment of the inventive web server in the second web server 10, which has an expansion module 11 with CNC functionality (CNC=Computer Numerical Controlled). The second web server 10 uses the expansion module 11 to control a computer-controlled machine tool 13 (CNC machine tool), which is used for the high-speed and accurate production of complex turned and milled components. Such complex control operations are generally executed by computers specifically for this purpose. A similarly complex control task is the control of a drive 18, which is taken over by the third web server 15 in the exemplary embodiment. It contains an expansion module 16 for this purpose, which takes over the demanding tasks of control or regulation of the drive 18. In order not to trade the advantages of the use of web technologies by the second and third web servers 10, 15 for the disadvantage of lack of security, the web servers 10, 15 are linked to the internet 1 via a firewall 8. The firewall 8 effectively prevents unauthorized access via a communication connection 7 to one of the web servers and therefore to the drive 18 or the machine tool 13. In a further exemplary embodiment of the invention shown in FIG. 1 the web server with automation functionality is a so-called embedded web server 20, which has a temperature regulator to control a valve 22 as an expansion module 21. This embedded web server 20 is provided for example in the form of a single chip solution within a personal computer (PC). In addition to the automation functionality of the expansion modules, each of the web servers 3, 10, 15, and 20 described offers all the functionalities and therefore all the advantages of a standard web server 24. The web browser 26 connected via the internet 1 can therefore also access the web servers 3, 10, 15 and 20 expanded to include automation functionality with web technologies and can therefore be used as control and monitoring systems. The exemplary embodiments shown in FIG. 1 clearly show the better scalability of the solution proposed here compared with conventional approaches. The web server can be configured as a single chip web server with a hardware add-on (e.g. in the consumer field) up to a high-performance web server with SoftPLC and office software.

FIG. 2 shows a schematic view of an exemplary embodiment of a web server with automation functionality. A web server 33 is connected via a connection 32 and a TCP/IP stack 31 to a TCP/IP connection 30. The web server 33 contains a first expansion module 34, which is configured as a database module and has access via a connection 35 to an SQL7 server 36 (SQL=Structure Query Language). A second expansion module 37 has automation functionality and communicates via a connection 38 with an industrial process 39. The expansion module 37, a software module, is linked via an interface (not shown here) to the connection 38 and thereby to the hardware components of the automation system to control the industrial process 39. As prebuilt software, the TCP/IP stack controls access to a network card (not shown here), which has access to the TCP/IP connection 30 and supplies the TCP/IP protocol to accessing processes.

FIG. 3 shows a schematic view of the structure of a further exemplary embodiment of a web server with automation functionality. Software components of the web server are shown. An operating system 50 of the computer on which the web server operates contains a standard operating system 51 and a real-time operating system 52. A web server kernel 54 is installed on the secondary operating system 50 by means of porting 53. The web server kernel 54 supplies standard interfaces for linking the software components and is the basis for various software expansion modules. A first expansion module 55 serves to provide web pages, a second expansion module 56 serves as an XML parser. A third expansion module 57 is used to connect a Profibus connection 58. A fourth expansion module 59 offers Java functionality, a fifth expansion module 60 processes signals from a webcam. A sixth expansion module 64 serves to process XML data. A seventh expansion module 61 with automation functionality has a connection 62 to a process and a connection 63 to an interface 65 with the real-time operating system 52. A system is deemed to be real-time-compatible, if it can react to random, external events within a specifiable and guaranteeable period. In industrial automation systems reaction times in microseconds are standard and necessary. Real-time processes can use all services that are also available to other processes.

The operating system 50 has direct access to the resources of the computer, e.g. storage unit and computing time. If a command is initiated or a program launched, the required program code is loaded into a main storage unit and started as a process. Processes do not have access to the resources but request these from the operating system. The direct integration of the automation functionality as the seventh expansion module 61 in the web server means that the performance, services (e.g. autotopology, SSDP, SNMP, e-mail, etc.) and the openness of the internet are accessible to the automation world and the further advantages described above are achieved. The seventh expansion module 61 on the one hand provides the automation solution and on the other hand it exchanges information via the web server and is configured and administered by this latter. In contrast, with a so-called SoftPLC (software simulation of a stored-program control) the automation function is not integrated into the server but is installed parallel to it, in some instances via a communication interface. Integration into the server signifies in particular that an expansion module is loaded, configured, started and terminated directly by the web server. Such an expansion module is frequently also referred to as an extension. The web server kernel 54 of the inventive web server serves as a common platform for the expansion modules. This facilitates in particular the configuration of the software expansion modules and their re-use in other applications. The expansion modules are not linked with proprietary or specifically programmed interfaces but with standard interfaces, e.g. API (Application Programming Interface) or CGI (Common Gateway Interface). API is a formally defined interface, by means of which application programs can use system services (network, operating systems, etc.) or services of other application programs. CGI describes a standard interface between a web server and programs. The seventh expansion module 61 has regulation and/or control means for regulating and/or controlling components and processes of an automation system as the means for providing an automation functionality. These regulation and control means for controlling an automation system are generally configured as executable software processes in the expansion module.

FIG. 4 shows a system with web servers 70, 71 connected via the internet 80 and a proprietary connection 78. A web server 70 with automation module 72 is connected via a connection 76 and its TCP/IP stack 77 to the internet 80. The automation module 72 communicates via a connection 73 with an industrial process 74. The automation module 72 integrated into the web server also has direct access with the connection 75 to a communication connection of the transport layer. The automation module 72 is therefore expanded to include access to the transport level/layer. This is generally the TCP/IP stack in the fourth layer (also referred to as layer 4) of the ISO/OSI model described below. A connection 78 of the transport layer between the TCP/IP stack 77 of the web server 70 and the TCP/IP stack 79 of a further web server 71 is used for communication by means of a proprietary protocol, e.g. a TCP/IP-based protocol (e.g. Ethernet, Profibus). The web server 71 also has an automation module 83, which is coupled via a connection 82 to the TCP/IP stack 79.

FIG. 5 shows a system with the combined use of a web server 70 with automation functionality, an automation device 93 and a conventional web server 95 without automation functionality. A web server 70 with automation module 72 is connected via a connection 76 and its TCP/IP stack 77 to the internet 80. The automation module 72 integrated into the web server also has direct access with the connection 75 to a communication connection of the transport layer. A connection 90 of the transport layer between the TCP/IP stack 77 of the web server 70 and the TCP/IP stack 91 of an automation device 93 is used for communication by means of a proprietary protocol, e.g. a TCP/IP-based protocol (e.g. Ethernet, Profibus). The conventional automation device 93 is coupled via a connection 82 to its TCP/IP stack 91. FIG. 5 also shows a conventional web server 95 without automation functionality, which is coupled by means of its TCP/IP stack 94 to the internet 80.

The problem that the internet protocols do not always have adequate capacity from the point of view of automation technology is thereby resolved in that access to the secondary protocol stack is enabled for the automation modules 72, 83 of the web server 70, 71. Proprietary high-speed communication can operate via these as before (e.g. with Ethernet or TCP/IP Ethernet). This is naturally of interest, especially in LAN environments (LAN=Local Area Network).

For clarification, the basic principles of the ISO/OSI reference model referred to in the description and the TCP/IP protocol are set out below. To describe the structure and function of protocols for data communication, an architecture model is frequently used, which was developed by the International Standards Organization (ISO). This basic reference model known as the Open Systems Interconnect (OSI) reference model creates a reference framework for the discussion of topics from the field of data communication. The ISO basic reference model comprises seven layers. Each of these layers defines certain functions of the protocols for data communication, which are executed during the exchange of data between applications across an intermediate network. Each individual layer does not define a protocol but rather represents a function of data communication, which can be executed by any number of protocols. Each layer can contain a plurality of protocols, each of which provides those services required for carrying out the function of said layer. The following model results:

The bottom, first layer defines the physical characteristics of the transmission routes and is therefore known as the physical layer. The second layer, known as the data link layer, ensures reliable transmission of data via the physical connections. The third layer, the network layer, administers the connections between computers in the network for the higher layers. The fourth layer or transport layer guarantees error-free data transmission by means of error identification and correction. The fifth layer, known as the session layer, administers the connections between the applications. The sixth layer or presentation layer standardizes the format of data on the network. The topmost seventh layer or application layer finally comprises the applications, with which the network can be used.

TCP/IP (Transmission Control Protocol/Internet Protocol) is the standard protocol stack for connection to the internet not only in UNIX but also on the PC (DOS, Windows, etc.). Advantages of TCP/IP include the open, manufacturer-independent protocol specifications, independence from a specific network medium and the standardized interface with application programs. Compared with the ISO/OSI model, TCP/IP protocol architecture is based on four layers. The bottom layer is known as the network access layer and it contains routines for access to physical networks. It corresponds to the bottom two layers of the ISO/OSI model. The second TCP/IP layer, the internet layer, defines the structure of datagrams and routes data and thereby corresponds to the third OSI layer. The third TCP/IP layer or transport layer provides end-to-end data services and corresponds to the fourth layer of the ISO/OSI model. The fourth TCP/IP layer, known as the application layer, contains applications and processes, which access the network, and thereby corresponds to the top three layers of the ISO/OSI model. The data migrates through the individual layers and is given a new header containing control information (known as capsulation) in each further layer down. During upward data transport, this additional information is removed again.

The proposed web server is part of a system of distributed applications set up in a client-server architecture. In such a system the task of a server as service provider is to carry out calculations or other internal processes at the request of a client and to formulate the results as protocol-compatible responses and forward these to the requesting client. Client here refers to a device or a process, which utilizes the service of one or a plurality of servers. Generally therefore the server provides a service passively and waits for a client to submit a request to it. The client on the other hand does not provide services but utilizes the services of a server. A server as service provider can thereby be present on the same device as the client or on a different device that can be accessed via a network (e.g. the internet). Client-server communication obeys certain rules and formal descriptions, known as protocols. It is an essential requirement for successful communication between client and server that both sides use the same protocol. Such a protocol generally specifies the communication channels and formats with which logon operations, information exchanges, requests, responses and logoff operations are effected. It is not always necessary for all these stages to be specified explicitly, if they are not significant for the purpose of the application. Protocols are specified at a wide range of abstraction levels and generally build on each other. This is then described as a layer model (e.g. the ISO/OSI layer model described above). While the lowest layers regulate the communication of hardware and devices—electrical signals, cables or radio frequencies and their characteristics are specified—the central layers deal with the structure of network topologies (address structures and their resolution, routing and error correction). The network layer (e.g. IP=Internet Protocol) and transport layer (e.g. TCP=Transmission Control Protocol) are often separated here. The top layers are referred to as the application layer. It is specified here how specific client-server applications communicate with each other. Examples of such protocols of the application layer are HTTP (Hyper Test Transfer Protocol), FTP (File Transfer Protocol) and SMTP (Simple Mail Transfer Protocol).

To summarize, the invention therefore relates to a web sever with software modules 72 integrated into the web server 70, supporting different types of communication. At least a first software module 72 has a first means for providing an automation functionality and a second means for direct access to a transport layer.

1-10. (canceled)

11. A web server comprising software modules, wherein at least a first software module comprises a first mechanism for providing an automation functionality and a second mechanism to directly access a transport layer.

12. The web server according to claim 11, wherein the web server comprises a connection to a communication network.

13. The web server according to claim 12, wherein the communication network is the Internet.

14. The web server according to claim 11, wherein internet protocols are provided for communication between the software modules themselves and for communication between the software modules and components outside the web server.

15. The web server according to claim 12, wherein Internet protocols are provided for communication between the software modules themselves and for communication between the software modules and components outside the web server.

16. The web server according to claim 11, wherein the web server is adapted to configure and administrate the software modules.

17. The web server according to claim 12, wherein the web server is adapted to configure and administrate the software modules.

18. The web server according to claim 14, wherein the web server is adapted to configure and administrate the software modules.

19. The web server according to claim 11, wherein the first software module comprises a connection to an industrial automation system.

20. The web server according to claim 12, wherein the first software module comprises a connection to an industrial automation system.

21. The web server according to claim 14, wherein the first software module comprises a connection to an industrial automation system.

22. The web server according to claim 16, wherein the first software module comprises a connection to an industrial automation system.

23. The web server according to claim 11, wherein the web server comprises a connection to the Internet using a firewall.

24. The web server according to claim 12, wherein the web server comprises a connection to the Internet using a firewall.

25. The web server according to claim 14, wherein the web server comprises a connection to the Internet using a firewall.

26. The web server according to claim 11, wherein the web server is connected via a communication network to a web browser, wherein the web browser is used as a control and monitoring system.

27. The web server according to claim 12, wherein the web server is connected via a communication network to a web browser, wherein the web browser is used as a control and monitoring system.

28. The web server according to claim 11, wherein the web server comprises a real-time operating system.

29. An automation system comprising a web server having software modules, wherein at least a first software module comprises a first mechanism for providing an automation functionality and a second mechanism to directly access a transport layer.

30. A computer program product comprising a web server having software modules, wherein at least a first software module comprises a first mechanism for providing an automation functionality and a second mechanism to directly access a transport layer.
